(19) United States
(12) Patent Application Publication
(10) Pub. No.: US 2025/0242824 A1
(43) Pub. Date: Jul. 31, 2025

(54) SYSTEM AND METHOD FOR PARKING WARNING

(71) Applicant: FOXCONN INTERCONNECT TECHNOLOGY LIMITED, Grand Cayman (KY)

(72) Inventor: Chung-Nan Ko, New Taipei (TW)

(21) Appl. No.: 18/910,236

(22) Filed: Oct. 9, 2024

(30) Foreign Application Priority Data
Jan. 25, 2024 (CN) 202410105059.0

(51) Int. Cl. B60W 50/14; B60N 2/00; G08G 1/16

(52) U.S. Cl. CPC B60W 50/14; B60N 2/002; G08G 1/168; B60W 2050/143; B60W 2050/146

(57) ABSTRACT

A method and system for parking warning are provided. The method includes obtaining the operational status of the vehicle. When the operational status of the vehicle indicating the vehicle is on a trajectory to a parking space, real-time environmental detection data between the vehicle and obstacles surrounding the vehicle at a preset distance is obtained. Then, based on the environmental detection data, a drop-off distance is estimated, which is used to indicate the distance between the vehicle and surrounding obstacles, before the vehicle is parked. Finally, when the drop-off distance is less than or equal to a distance threshold, a warning message is output.

### CROSS-REFERENCE TO RELATED APPLICATIONS

This application claims priority to Chinese Patent Application No. 202410105059.0 filed on Jan. 25, 2024, in China National Intellectual Property Administration, the contents of which are incorporated by reference herein.

### FIELD

The subject matter herein generally relates to parking technologies, and specially relates to a system and a method for parking warning.

### BACKGROUND

There may be obstacles around a parking area, such as walls, load-bearing columns, or vehicles. After a vehicle enters the parking area, the vehicle may need to re-park due to the car door being too close to the obstacle, potentially causing issues when trying to open the car door. However, re-parking will increase a parking time and reduce a parking efficiency.

Therefore, there is room for improvement within the art.

### BRIEF DESCRIPTION OF THE DRAWINGS

Implementations of the present disclosure will now be described, by way of example only, with reference to the attached figures.

FIG. 1 is a schematic diagram illustrating a parking warning system according to an embodiment of the present disclosure.

FIG. 2 is a schematic diagram illustrating a control device according to an embodiment of the present disclosure.

FIG. 3 is a schematic diagram illustrating a vehicle according to an embodiment of the present disclosure.

FIG. 4 is a flow chart illustrating a method for parking warning according to an embodiment of the present disclosure.

FIG. 5 is a flow chart illustrating a method for obtaining an operational status of the vehicle according to an embodiment of the present disclosure.

FIG. 6 is a flow chart illustrating a method for obtaining an operational status of the vehicle according to another embodiment of the present disclosure.

FIG. 7 is a schematic diagram illustrating a parking scenario according to an embodiment of the present disclosure.

FIG. 8 is a schematic diagram illustrating a parking scenario according to another embodiment of the present disclosure.

FIG. 9 is a schematic diagram illustrating a parking scenario according to another embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better show details and features of the present disclosure.

Several definitions that apply throughout this disclosure will now be presented.

The term “coupled” is defined as connected, whether directly or indirectly through intervening components, and is not necessarily limited to physical connections. The connection may be such that the objects are permanently connected or releasably connected. The term “comprising,” when utilized, means “including, but not necessarily limited to”; it specifically indicates open-ended inclusion or membership in the so-described combination, group, series, and the like.

The parking warning method and parking warning system provided in this embodiment may be applied to a vehicle provided in this embodiment as well.

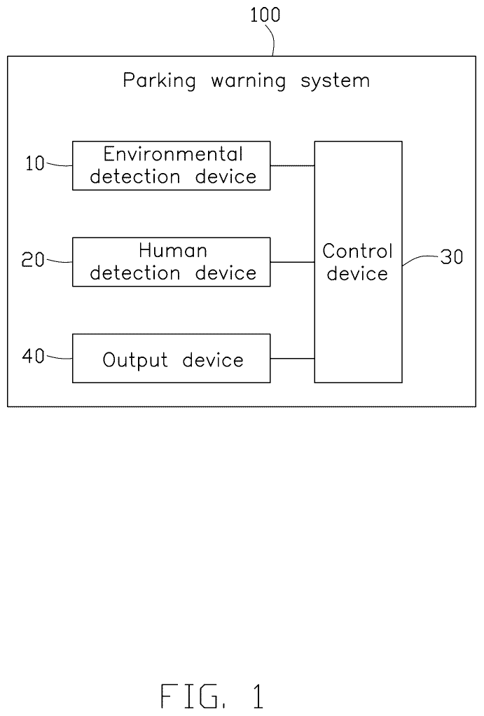

FIG. 1 illustrates a parking warning system 100. The parking warning system 100 includes an environmental detection device 10, a human detection device 20, a control device 30, and an output device 40.

The environmental detection device 10 is used to detect environment information around the vehicle. The environment information includes an environmental detection data between the vehicle and the obstacles surrounding. In this embodiment, the environmental detection data includes distance-related data and/or direction-related data.

In one embodiment, the distance-related data can include a first distance between the vehicle and the obstacles around. The first distance may be a first straight-line distance between a target detection point on the obstacle and the vehicle. The first distance also may be a second straight-line distance between the target detection point and the environmental detection device 10 on the vehicle.

In other embodiments, the distance-related data can include the first distance and a second distance. The second distance may be a distance between the environmental detection device 10 and a first detection point. The first detection point is a point on a virtual straight line along which the vehicle is driving. Specifically, the first detection point is the point where the target detection point being perpendicular to and intersects the virtual straight line.

The directional information may include, but is not limited to, angles and bearings. For example, the directional information can include a first angle between the vehicle and the obstacle around. The first angle is used to indicate an offset angle of the vehicle or the environmental detection device 10 relative to the obstacle. Specifically, the first angle can be the angle between a driving direction of the vehicle and a first direction. The first direction is the direction of the environmental detection device 10 pointing to the target detection point.

In other embodiments, the direction-related data can include a location of the obstacles around the vehicle or the target detection point relative to the vehicle, such as east, south, west, north, southeast, northwest, northeast, southwest, etc.

In some embodiments, the environmental detection data may also include obstacle information, for example, a location of the obstacle, a size of the obstacle, etc.

In this embodiment, the obstacles may include, but are not limited to, objects around the vehicle during and/or after parking. For example, after parking, any object around the vehicle that would prevent the passengers and/or a driver from opening the door to exit is considered an obstacle. The obstacles may include, but are not limited to, other vehicle, walls, and load-bearing columns.

The environmental detection device 10 may include a first function and a second function. The first function is used to obtain the distance-related data, such as the first distance and/or the second distance. The second function is used to obtain the direction-related data, such as the first angle. The environmental detection device 10 may be a sensor with both the first function and the second function. The environmental detection device 10 also may include a first sensor with the first function and a second sensor with the second function.

In this embodiment, the environmental monitoring device 10 may include, but is not limited to, an ultrasonic ranging sensor, a millimeter wave radar sensor, an Ultrasonic Sensor System (USS), a laser rangefinder, and/or an image ranging sensor.

Taking a distance detection as an example, the ultrasonic ranging sensor uses the propagation of sound waves in the air to measure a distance. The laser rangefinder can use a laser transmitter to send out a laser beam and calculate the distance by receiving the light signal reflected back. The image ranging sensor obtains the image information through a camera, analyzes the image information and calculates the distance by applying an algorithm.

Taking an angle detection an example, the millimeter wave radar sensor is installed on the vehicle. The millimeter wave radar sensor uses a phase difference between a signal transmission and a signal reception of the millimeter wave band to calculate the angle between a target object (e.g., the object around the vehicle) and the millimeter wave radar sensor. Specifically, the millimeter wave radar sensor transmits a modulated millimeter wave signal. The modulated millimeter wave signal is reflected back by the target object after transmission through an antenna and is received by the antenna. By calculating the phase difference between the transmitted and received signals, the angle information between the target object and the millimeter wave radar sensor can be obtained.

It can be understood that the environmental detection device 10 can be a variety of combinations, such as a combination of the image ranging sensors, the ultrasonic radar, and the millimeter-wave radar sensors.

The human detection device 20 is used to detect whether there is a human around the vehicle to obtain human information.

The human detection device 20 may include, but are not limited to, a pressure sensor, an infrared sensor, an ultrasonic sensor, a microwave radar sensor, and/or a video image processing device.

The pressure sensor determines whether a human around the vehicle by a pressure applied by the human. The infrared sensors can detect whether a human in a detection range by sensing an infrared radiation emitted by the human. The ultrasonic sensors can detect whether a human is approaching by emitting ultrasonic waves and sensing echoes of the ultrasonic waves. The microwave radar sensors can detect whether a human around the vehicle by emitting microwaves and sensing reflections of the microwaves. The video image processing device can determine whether there is a human around the vehicle by analyzing human contours, colors, and other information of a video image.

In some embodiments, the human detection device 20 may be a combination of any two or more of the above sensors.

The control device 30 is used to execute the parking warning method provided in this embodiment. In this embodiment, when executes the parking warning method, the control device 30 may provide a parking warning service. The parking warning service may include, but is not limited to, obtaining the environmental detection data, obtaining the human detection data, predicting drop-off distance, and outputting warning messages.

The warning messages may include, but are not limited to, the distance between the vehicle and obstacles and a warning about exiting the vehicle. The warning about exiting the vehicle is used to prompt passengers and/or driver to exit the vehicle.

Specifically, the control device 30 may activate the environmental detection device 10 and/or the human detection device 20 to obtain the predicted distance data detected by the environmental detection device 10, and/or, to obtain the human detection data detected by the human detection device 20.

The control device 30 can also predict a drop-off distance based on the environmental detection data. The control device 30 can output the predicted drop-off distance.

In some embodiments, the control device 30 can also construct spatial models of parking spaces and parked vehicles based on the environmental detection data. The spatial models include locations and dimensions.

The control device 30 can determine whether to output the warning message according to the drop-off distance. The control device 30 can determine whether to output the warning message according to the drop-off distance and the human detection data.

The control device 30 may include, but is not limited to, an Electronic Control Unit (ECU), an in-vehicle system, a vehicle server, and/or a communication device. The vehicle server can be a network side device. The vehicle can be a whole device or a chip of a device.

Taking the control device 30 being an ECU as an example, the ECU communicates with the environmental detection device 10, the human detection device 20, and the output device 40. When implementing the parking warning method, the ECU can predict the drop-off distance according to the data detected by the environmental detection device 10 and the human detection device 20, and can also output the warning message through the output device 40.

Taking the control device 30 being an ECU, a vehicle server, and a communication device as an example. The communication device is used to facilitate communication between the ECU and the vehicle server. The ECU establishes communication connections with the environmental detection device 10, the human detection device 20, and the output device 40. The ECU executes the parking warning method provided in this embodiment, obtains the predicted distance data detected by the environmental detection device 10, and obtains the human detection data detected by the human detection device 20, and transmits the predicted distance data and the human detection data to the vehicle server through the communication device. The vehicle server then executes the parking warning method to predict the vehicle's drop-off distance based on the predicted distance data and the human detection data. When the predicted drop-off distance is less than a distance threshold, the warning message is output to the ECU through the communication device. The ECU outputs the received warning message to the driver and/or passengers via the output device 40.

In this embodiment, when the control device 30 includes at least two of the ECU, the vehicle server, and the communication device, the at least two of the ECU, the vehicle server, and the communication device may jointly perform the parking warning method.

The output device 40 is used to output relevant information of the vehicle. The relevant information of the vehicle may include, but is not limited to, the warning message. In this embodiment, the output device 40 can be a device capable of outputting images, text, symbols, and speech. For example, the output device 40 may include, but is not limited to, a touch screen and a speaker.

In this embodiment, the number of any one of the environmental detection devices 10, the human detection devices 20, and the output devices 40 may be one, or two or more, which is not limited.

In some embodiments, when the number of any one of the above devices (e.g., the environmental detection devices 10, the human detection devices 20, and the output devices 40) is multiple, the types of the multiple devices can be the same or different. For example, when the number of the environmental detection devices 10 is two, the two environmental detection devices 10 can be of the same type, such as ultrasonic ranging sensors. The two environmental detection devices 10 may also be of different types, such as an ultrasonic ranging sensor and a laser rangefinder.

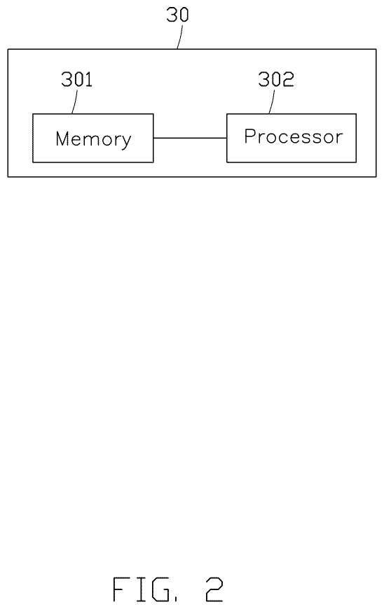

As shown in FIG. 2, the control device 30 includes a memory 301, a processor 302, and a computer program. The computer program is stored in the memory 301 and can be run by the processor 302.

The processor 302 is used to execute the computer program to implement the parking warning method. In this embodiment, the processor 302 can be a Central Processing Unit (CPU) or other general-purpose processors. The processor 302 implements various functions of the control device 30 by running or executing the computer programs and/or modules/units stored in the memory 301 and by invoking data stored in the memory 301.

In this embodiment, the vehicle provided may include, but is not limited to, a car, a truck, a bus, and a trailer.

Following, taking the environmental detection device 10 including the first environmental detection device 101 and the second environmental detection device 102, the human detection device 20 including the first pressure sensor 21 and the second pressure sensor 22, and the control device 30 being the ECU 31 on the vehicle as an example.

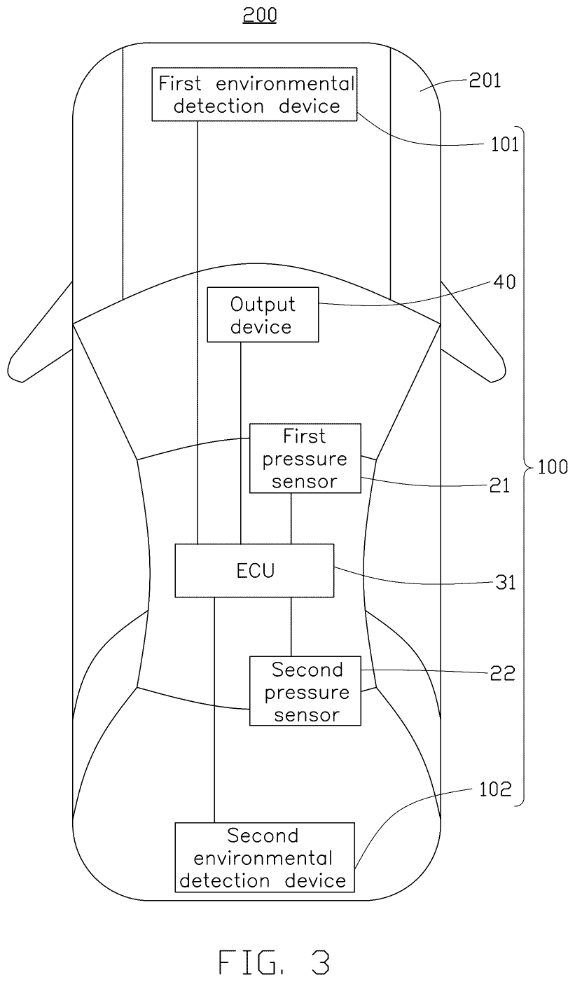

As shown in FIG. 3, the vehicle 200 includes a vehicle body 201 and a parking warning system 100. The ECU 31 communicates with the first environmental detection device 101, the second environmental detection device 102, the first pressure sensor 21, the second pressure sensor 22, and the output device 40. The first environmental detection device 101 is positioned at the front of the vehicle, and the second environmental detection device 102 is positioned at the rear of the vehicle. The first pressure sensor 21 is installed in the front passenger seat, and the second pressure sensor 22 is installed in the rear seats.

In this embodiment, when the pressure detected by the first pressure sensor 21 in the front passenger seat is greater than a pressure threshold, it is determined that there is a human presence in the front passenger seat.

In some embodiments, the human detection device 20 may include more than one second pressure sensor 22.

In some embodiments, the parking warning system 100 includes two first environmental detection devices 101 and two second environmental detection devices 102. The two first environmental detection devices 101 are arranged near the left headlight and the right headlight respectively. The two second environmental detection devices 102 are arranged near the left taillight and the right taillight respectively.

The parking warning system 100 can be arranged on the vehicle according to the actual situation. For example, the environmental detection device 10 may be installed on each door, which is not limited.

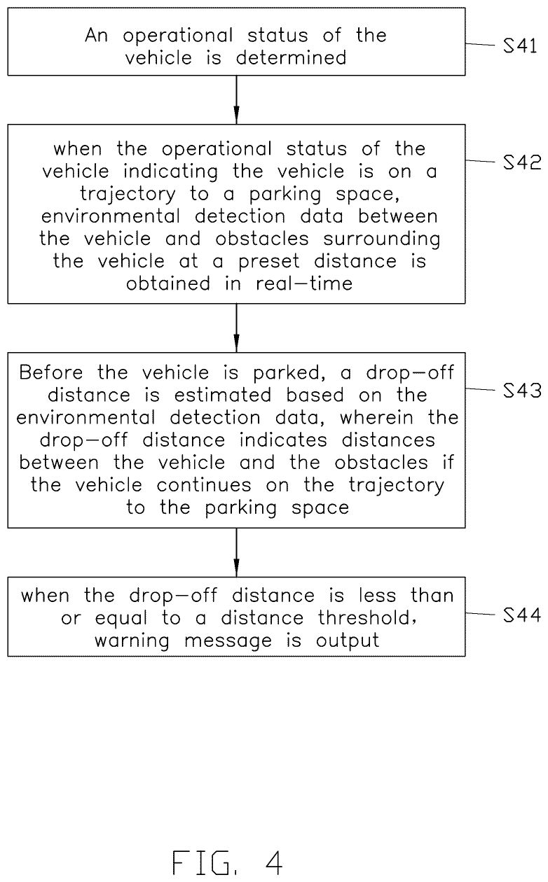

FIG. 4 illustrates a parking warning method according to an embodiment of the present disclosure. According to different needs, the sequence of blocks in the parking warning method provided by this embodiment may be changed and some blocks may be omitted. In this embodiment, an execution subject of the parking warning method provided in this application may be the control device 30. The execution subject of this application may be implemented by software and/or hardware, and may be integrated in various general purpose computer equipment, such as the above-mentioned ECU, vehicle server, etc. For ease of description, the ECU is taken as an example below. It can be understood that the execution subject of the parking warning method based on the ECU is only an example explanation and should not be understood as a limitation of the method.

As shown in FIG. 4, the parking warning method includes blocks S41 to S44.

At block S41, an operational status of the vehicle is determined.

The operational status of the vehicle may include, but is not limited to, a driving state, a temporary parking state, and a parking state.

The driving state indicates that the vehicle is in motion. For example, when the vehicle is traveling on a highway, the vehicle is in the driving state.

The temporary stop state indicates that the vehicle is at rest for a preset period of time, and after this preset time, the vehicle is in the driving state. For example, when the vehicle is at a red light, the vehicle is temporarily stopped.

The parking state indicates that the vehicle has driven to a parking area and is turned off once it enters the parking space, in other words, the parking status indicates the vehicle is on a trajectory to the parking space For example, the vehicle is in the parking state when it is ready to park and has entered the designated parking area. The driver then turns off the vehicle after parking it.

In this embodiment, in the temporary parking state, the vehicle is not turned off while it is at rest, whereas in the parking state, the vehicle is turned off when the vehicle is at rest. The duration of rest in the parking state is longer than the preset time for the temporary parking state.

When the vehicle is ready to park, it may proceed straight, it can also turn, or it may turn after proceeding straight, etc. This embodiment does not specify the exact maneuvers required for parking.

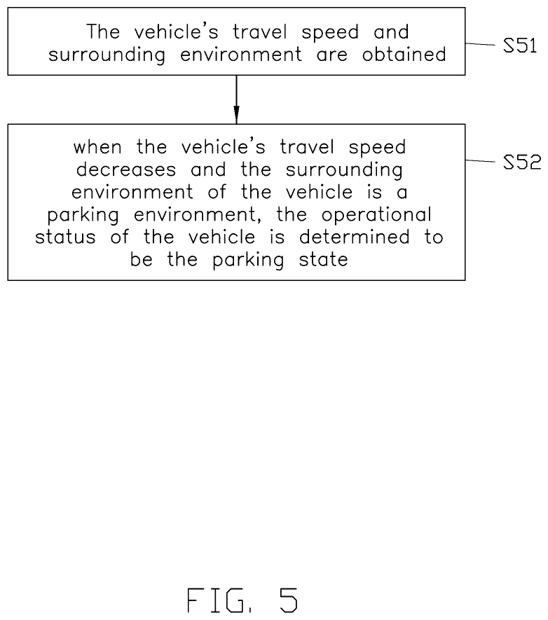

FIG. 5 illustrates a flow chart of block S41 in FIG. 4 according to an embodiment of the present disclosure. As shown in FIG. 5, in some embodiments, the block S41 includes blocks 551 and S52.

At block S51, the vehicle's travel speed and surrounding environment are obtained.

The means of obtaining the speed of the vehicle may include, but are not limited to, accurate calculation of the speed of the vehicle through the Global Positioning System (GPS).

The methods of obtaining information about the surrounding environment of the vehicle may include, but are not limited to, obtaining an image of the surrounding environment through a camera device set on the outside of the vehicle, and analyzing the image of the surrounding environment to determine the vehicle's surrounding environment.

At block S52, when the vehicle's travel speed decreases and the surrounding environment of the vehicle is a parking environment, the operational status of the vehicle is determined to be the parking state.

Analyze the images of the vehicle's surrounding environment, and identify the vehicle's surrounding environment as a parking environment when a parking area and/or a parking sign are detected. The parking signs may include, but are not limited to, parking space signs, parking lot signs, and limited duration parking signs.

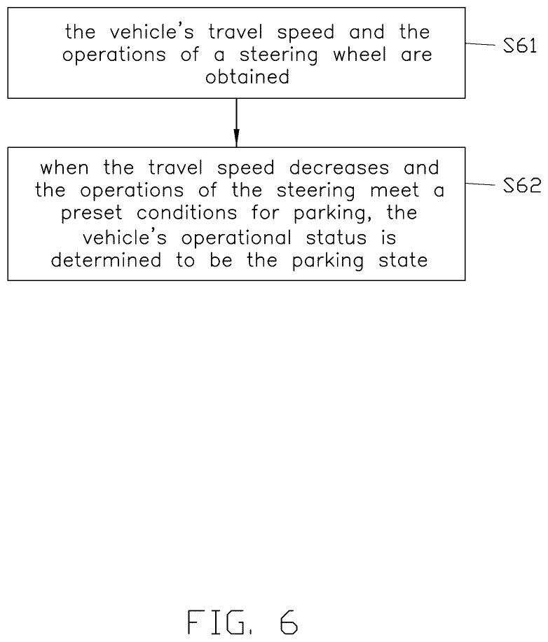

FIG. 6 illustrates another flow chart of block S41 in FIG. 4 according to an embodiment of the present disclosure. As shown in FIG. 6, in some embodiments, the block S41 includes blocks S61 and S62.

At block S61, the vehicle's travel speed and the operations of a steering wheel are obtained.

The way to obtain the driving speed of the vehicle can be referred to above, and will not be repeated here.

The steering wheel operation can include steering wheel rotation direction and rotation speed.

Methods of obtaining steering wheel operation may include, but are not limited to, an angle sensor located on the steering wheel and electrically connected to the control device. The control device can determine the steering wheel operation based on the data detected by the angle sensor.

In other embodiments, the ECU can also directly read a user's operation of the steering wheel.

At block S62, when the travel speed decreases and the operations of the steering meet a preset conditions for parking, the vehicle's operational status is determined to be the parking state.

In this embodiment, different scenarios for the parking area can be predefined, and the steering wheel operations made by the driver during parking in these various scenarios can be collected, including the steering wheel's rotation direction and speed. Based on this data, preset parking operation conditions can then be established.

When the rotation direction and speed of the steering wheel align with the preset parking operation conditions, and the vehicle's driving speed decreases, the vehicle's operational status is determined to be the parking state.

In other embodiments, the vehicle's operational status is determined to be in the parking state, based on the vehicle's duration in the parking environment reaching a preset first duration. The preset first duration can be set according to the actual situation.

As shown in FIG. 3, the method further includes block S42.

At block S42, when the operational status of the vehicle indicating the vehicle is on a trajectory to a parking space, environmental detection data between the vehicle and obstacles surrounding the vehicle at a preset distance is obtained in real-time.

In this embodiment, when the operational status of the vehicle is the parking state, there may be various obstacles around the vehicle. If the vehicle is about to enter a target parking space, there may be obstacles located on one or more sides of the space. The environmental detection data between the vehicle and surrounding obstacles can be obtained in real time through the environmental detection device.

In other embodiments, before obtaining the environmental detection data between the vehicle and surrounding obstacles in real time, it is determined that the operational status of the vehicle is the parking state and the driving direction of the vehicle is straight. Additionally, the driving direction of the vehicle is straight, that is, the driving path of the vehicle is straight or close to the line.

In other embodiments, before obtaining the environmental detection data between the vehicle and its surrounding obstacles in real time, it is determined that there is a human presence in the front passenger seat and/or the rear seats of the vehicle, the operational status of the vehicle is the parking state, and the driving direction of the vehicle is straight.

Specifically, the control device obtains the human detection data detected by the human detection devices, and based on the human detection data, determines whether there is a human presence in the front passenger seat and/or the rear seats of the vehicle. When there is a human presence in the front passenger seat and/or the rear seats of the vehicle, the operational status of the vehicle is the parking state, and the driving direction of the vehicle is straight, the control device obtains the environmental detection data between the vehicle and surrounding obstacles in real time through the environmental detection device.

In other embodiments, when there is no human presence in the front passenger seat and/or the rear seats of the vehicle, and the operational status of the vehicle is the parking state, and the driving direction of the vehicle is straight, the control device obtains the environmental detection data between the vehicle and the surrounding obstacles in real time through the environmental detection device.

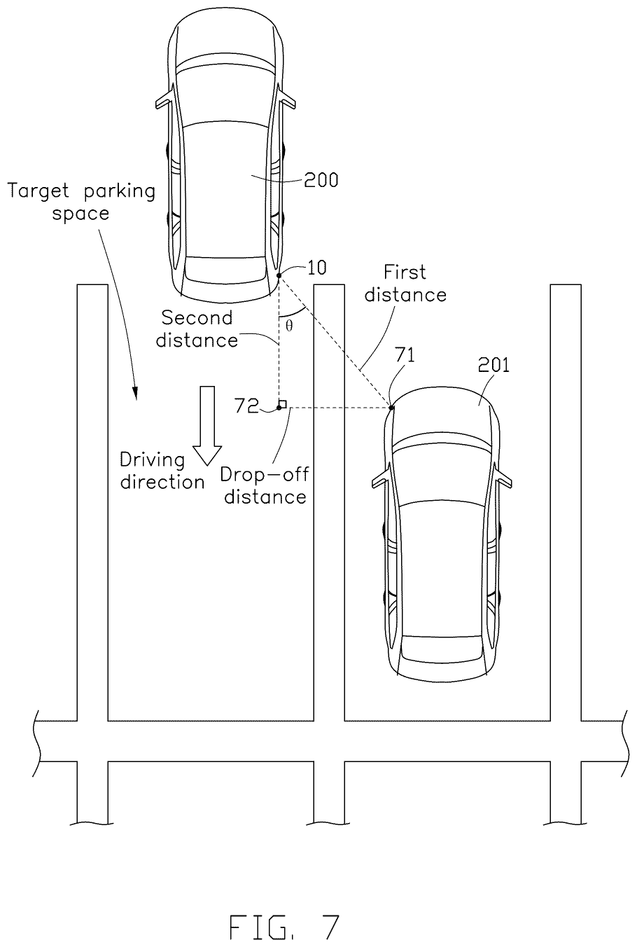

FIG. 7 illustrates a scenario where vehicle 200 is in the parking state and the driving direction of the vehicle is straight. The vehicle 200 is entering a target parking space, and an adjacent vehicle 201 is parked in the parking space adjacent to the target one. The adjacent vehicle 201 serves as an obstacle. As the vehicle 200 pulls into the target parking space, the environmental detection data between vehicle 200 and the adjacent vehicle 201 is obtained in real time.

In this embodiment, when adjacent parking spaces on both sides of the target parking space are occupied by adjacent vehicles A and B, both adjacent vehicles A and B are obstacles. When the vehicle 200 drives into the target parking space, the environmental detection data between the vehicle 200 and the adjacent vehicle A, as well as between the vehicle 200 and the adjacent vehicle B, are obtained in real time.

In this embodiment, real-time acquisition of the environmental detection data between vehicle 200 and surrounding obstacles may include: real-time acquisition of the first distance and/or the second distance and/or the first angle between the vehicle 200 and surrounding obstacles through the environmental detection device.

As shown in FIG. 7, the first distance is the distance between the environmental detection device 10 and a target detection point 71 on the adjacent vehicle 201. The second distance is the distance between the environmental detection device 10 and a first detection point 72. Furthermore, as depicted in FIG. 7, a right triangle is formed between the line segment of the first distance, the line segment of the second distance, and the line segment of the drop-off distance. The line segment representing the first distance is the hypotenuse of the right triangle, and the line segment of the second distance and the line segment of the drop-off distance is the right side of the right triangle.

A first angle θ is the angle between the driving direction of the vehicle and the first direction, and the first direction is the direction from the environmental detection device 10 pointing towards the target detection point 71. The first angle θ is also the angle between the line segment of the first distance and the line segment of the second distance. The first angle θ can be measured by the environmental detection device 10, and this measured angle reflects the orientation of the device 10 relative to the adjacent vehicle 201. Alternatively, the first angle θ can be understood as the offset angle from the vehicle's reference direction, such as its driving direction, to the direction of the environmental detection device 10 pointing to the target detection point 71.

In this embodiment, when the first environmental detection device is installed at the front end of the vehicle and the second environmental detection device is installed at the back end of the vehicle, the first distance and the first angle between the vehicle and surrounding obstacles can be obtained in real time as follows, when the vehicle is moving forward, the first distance and the first angle are obtained in real time through the first environmental detection device. When the vehicle is driving backwards, the first distance and the first angle are obtained in real time through the second environmental detection device.

In this embodiment, the way to obtain whether the vehicle is driving forward or backward may include but is not limited to detecting the vehicle's rotation direction determining that the vehicle is driving forward when the wheel rotates clockwise, and determining that the vehicle is driving backward when the wheel turns counterclockwise.

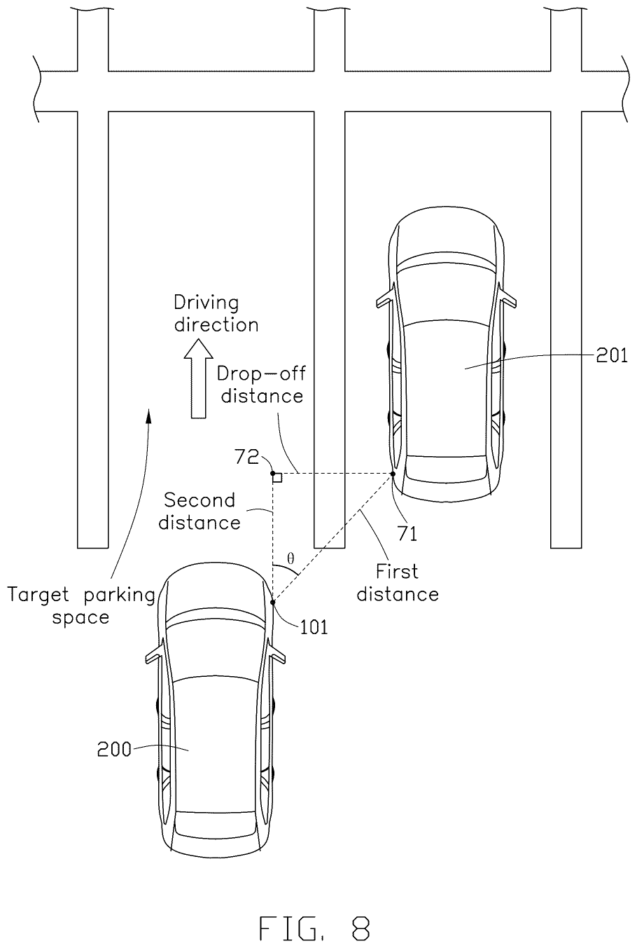

As shown in FIG. 8, when the vehicle 200 is moving forward, obtain the first distance between the first environmental detection device 101 and the target detection point 71 on the adjacent vehicle 201, and/or the first angle θ between the forward direction and a connection line between the first environmental detection device 101 and the target detection point 71, and/or the second distance between the target detection point 71 and the first environmental detection device 101.

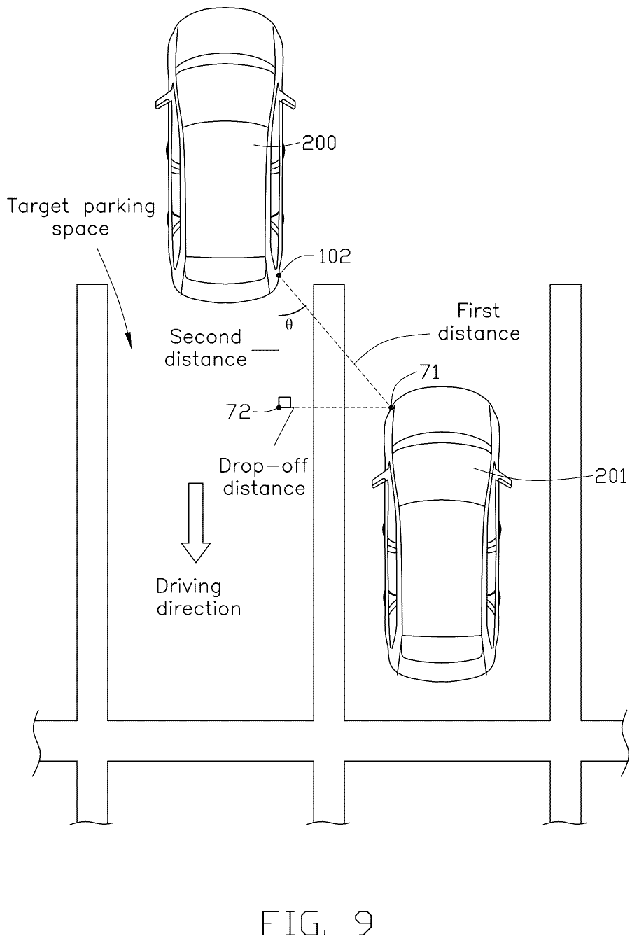

As shown in FIG. 9, when the vehicle 200 is driving backward, obtain the first distance between the second environmental detection device 102 and the target detection point 71 on the adjacent vehicle 201, and/or the first angle θ between the direction of travel and a connection line between the second environmental detection device 102 and the target detection point 71, and/or the second distance between the target detection point 71 and the second environmental detection device 102.

As shown in FIG. 3, the method further includes block S43.

At block S43, before the vehicle is parked, a drop-off distance is estimated based on the environmental detection data, wherein the drop-off distance indicates distances between the vehicle and the obstacles if the vehicle continues on the trajectory to the parking space.

As shown in FIGS. 7 to 9, the line segment of the first distance, the line segment of the second distance, and the line segment of the drop-off distance can form a right-angled triangle. Thus, the drop-off distance can be calculated based on the first distance and the first angle. The first angle between the line segment of the first distance and a reference line, such as the line segment of the second distance, the vehicle's direction of travel, or a perpendicular to the vehicle's position.

Specifically, the drop-off distance is:

$$L 2 = L 1 ⋆ sin θ$$

Where L1 is the first distance, L2 is the drop-off distance, and θ is the first angle.

In this embodiment, when there are multiple obstacles, the drop-off distance is calculated according to the environmental detection data corresponding to the multiple obstacles. As in the example above, the drop-off distance between the vehicle and the adjacent vehicle A is calculated based on the environmental detection data between the vehicle and the adjacent vehicle A. The drop-off distance between the vehicle and the adjacent vehicle B is calculated according to the environmental detection data between the vehicle and the adjacent vehicle B.

In other embodiments, the drop-off distance can be calculated from the first distance, the second distance, and the Pythagorean theorem.

At block S44, when the drop-off distance is less than or equal to a distance threshold, warning message is output.

In this embodiment, the distance threshold is the minimum distance between the vehicle and the obstacle to ensure that the driver and/or passengers can get off normally after the vehicle is parked. When the drop-off distance is lower than the distance threshold, it means that the predicted drop-off distance after the vehicle parking cannot meet the needs of the driver and/or passengers to move from the space inside the vehicle to the outside of the vehicle, so the vehicle can output warning message to remind the driver and/or passengers, so that the driver can stop before the vehicle stops according to the warning message, so that the passengers on the vehicle can get off in advance, and then prevent the vehicle from parking after the vehicle is parked. Only to find that the passengers cannot get off and need to move forward or back to let the passengers get off, and then re-enter the parking area.

In this embodiment, the distance threshold can be se according to the way the doors of vehicle 100 are opened. Specifically, the opening mode of the door can be determined according to the vehicle model, and then the appropriate distance threshold can be set based on the opening mode of the door. It can be understood that different models correspond to different door opening methods, and different door opening methods correspond to different distance thresholds.

In other embodiments, the distance threshold can also be set based on the user's body shape data. The user shape data can be pre-stored in the vehicle, and it can be determined based on the general body types prevalent in the area where the vehicle is located.

In other embodiments, the distance threshold can also be set based on the way the door is opened and the user's body shape data.

In other embodiments, the distance threshold for when no human is present in the co-driver position and/or the rear seat position of the vehicle may be the same as, or different from, the distance threshold for when a human is present in those positions.

In this embodiment, the distance threshold can be set according to the actual situation, and can take values such as 50 cm, 45 cm, or 60 cm, without specific limitation in this embodiment. In other embodiments, when only one side of the parking area is obstructed, the driver and/or passengers may still exit the vehicle through the unobstructed side, even if the predicted drop-off distance on the obstructed side is below the distance threshold. Consequently, no warning message will be output in such cases.

In other embodiments, even if there is an obstacle on only one side of the parking area, the warning message can be output when the predicted drop-off distance is below the distance threshold.

In some embodiments, when there are obstacles on both sides of the parking area, and the corresponding drop-off distance on both sides is lower than the distance threshold, the warning message can be output.

In this embodiment, the warning message can be output through the output device. The warning message can be displayed on the display of the vehicle's central control system, or it can also be displayed on the vehicle's rearview mirror to be able to alert the user.

In some embodiments, the warning message may also be broadcast by voice.

In this embodiment, the operational status of the vehicle is obtained. When the operational status of the vehicle is the parking status, the environmental detection data between the vehicle and surrounding obstacles are obtained in real time, and the drop-off distance is predicted according to the environmental detection data. The drop-off distance is used to indicate the distance between the vehicle and surrounding obstacles after parking. Output the warning message to determine whether passengers can move from the interior space to the outside of the vehicle based on the predicted exit distance before the vehicle enters the target parking space. When the alighting distance is lower than the distance threshold, it means that the predicted drop-off distance after the vehicle parks in the target parking space cannot meet the needs of the driver and/or passengers to move from the interior space to the outside of the car. Therefore, the warning message can be output to remind the driver and/or passengers, so that the driver and/or passengers can stop before entering the target parking space according to the warning message, so that the passengers on the car can get off in advance, and then prevent the vehicle from parking in the parking space. Only to find that the passengers cannot get off and need to move forward or back to let the passengers get off and then re-enter the parking space, which can reduce the parking time and improve the user's experience.

In this embodiment, the driver can know through the warning message that after the vehicle is parked in the target parking space, the spacing distance between the vehicle and the obstacle cannot meet the requirements for getting off. In this case, the driver can adjust the parking path of the vehicle according to needs, so that the spacing distance between the vehicle and the obstacle can meet the requirements for getting off after the vehicle is parked in the parking space.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for parking warning, comprising:
determining an operational status of a vehicle;
acquiring, in real-time, environmental detection data between the vehicle and obstacles surrounding the vehicle at a preset distance, when the operational status of the vehicle indicating the vehicle is on a trajectory to a parking space;
estimating a drop-off distance, before the vehicle is parked, and based on the environmental detection data, wherein the drop-off distance indicates distances between the vehicle and the obstacles if the vehicle continues on the trajectory to the parking space; and
outputting a warning message when the drop-off distance is less than or equal to a distance threshold.

2. The method of claim 1, wherein before acquiring, in real-time, environmental detection data between the vehicle and the obstacles, the method further comprises:
determining whether a driving direction of the vehicle is straight and the operational status of the vehicle is in a parking state.

3. The method of claim 1, wherein before acquiring, in real-time, environmental detection data between the vehicle and the obstacles, the method further comprises:
determining whether a driving direction of the vehicle is straight and the operational status of the vehicle is in a parking state;
determining whether the front passenger seat and/or the rear seats of the vehicle is occupied by at least one passenger.

4. The method of claim 1, wherein the environmental detection data comprises a first distance and a first angle between the vehicle and the obstacles;
the first distance and the first angle are acquired by an environmental detection device installed on the vehicle;
the first distance is a distance between the environmental detection device and the obstacle;
the first angle is a deviation angle of the environmental detection device relative to the obstacle.

5. The method of claim 4, wherein the environmental detection device comprises a first environmental detection device and a second environmental detection device, the first environmental detection device is installed at the front end of the vehicle, and the second environmental detection device is installed at the back end of the vehicle;
the first environmental detection device is configured to acquire the first distance and the first angle, when the vehicle moves forward;
the second environmental detection device is configured to acquire the first distance and the first angle, when the vehicle moves backward.

6. The method of claim 1, wherein determining the operational status of the vehicle comprises:
obtaining a travel speed and an environment surrounding the vehicle;
determining the operational status of the vehicle is in the parking state, when the travel speed decreases and the environment is identified as a parking environment.

7. The method of claim 4, wherein determining the operational status of the vehicle comprises:
obtaining a travel speed of the vehicle and operations of a steering wheel of the vehicle;
determining the operational status of the vehicle is in the parking state, when the travel speed decreases and the operations of the steering meet preset conditions for parking a vehicle.

8. The method of claim 3, further comprising:
obtaining detection data detected by a human detection device, wherein the human detection device is installed in the passenger seat and the rear seats;
the determining whether the front passenger seat and/or the rear seats of the vehicle is occupied by at least one passenger is based on the detection data from the human detection device.

9. The method of claim 1, wherein the outputting the warning message comprises outputting at least one of text, image, and voice by an output device.

10. The method of claim 1, further comprising setting the distance threshold according to an open manner of a door of the vehicle.

11. A parking warning system comprising:
an environmental detection device, configured to detect environmental detection data between a vehicle and obstacles surrounding the vehicle;
a control device, configured to:
determine an operational status of the vehicle;
acquire, in real-time, the environmental detection data between the vehicle and obstacles surrounding the vehicle at a preset distance, when the operational status of the vehicle indicates the vehicle is on a trajectory to a parking space;
estimate a drop-off distance, before the vehicle is parked, and based on the environmental detection data, wherein the drop-off distance indicates distances between the vehicle and the obstacles if the vehicle continues on the trajectory to the parking space;
output a warning message when the drop-off distance is less than or equal to a distance threshold;
an output device, configured to output the warning message.

12. The system of claim 11, wherein before acquire, in real-time, the environmental detection data between the vehicle and the obstacles, the control device is further configured to:
determine whether a driving direction of the vehicle is straight and the operational status of the vehicle is in a parking state.

13. The system of claim 11, wherein before acquire, in real-time, the environmental detection data between the vehicle and the obstacles, the control device is further configured to:
determine whether a driving direction of the vehicle is straight and the operational status of the vehicle is in a parking state;
determine whether a human presence in the front passenger seat and/or rear seats of the vehicle is occupied by at least one passenger.

14. The system of claim 11, wherein the environmental detection data comprises a first distance and a first angle between the vehicle and the obstacles;
the first distance is a distance between the environmental detection device and the obstacle;
the first angle is a deviation angle of the environmental detection device relative to the obstacle.

15. The system of claim 14, wherein the environmental detection device comprises a first environmental detection device and a second environmental detection device, the first environmental detection device is installed at the front end of the vehicle, and the second environmental detection device is installed at the back end of the vehicle;
the first environmental detection device is configured to acquire the first distance and the first angle, when the vehicle moves forward;
the second environmental detection device is configured to acquire the first distance and the first angle, when the vehicle moves backward.

16. The system of claim 1, wherein determine an operational status of the vehicle, the control device is further configured to:
obtain a travel speed and an environment surrounding the vehicle;
determine the operational status of the vehicle is in the parking state, when the travel speed decreases and the environment is identified as a parking environment.

17. The system of claim 1, wherein determine an operational status of the vehicle, the control device is further configured to:
obtain a travel speed of the vehicle and operations of a steering wheel of the vehicle;
determine the operational status of the vehicle is in the parking state, when the travel speed decreases and the operations of the steering meet preset conditions for parking a vehicle.

18. The system of claim 13, wherein the parking warning system further comprising a human detection device installed in the passenger seat and the rear seats, the control device is further configured to:
obtain detection data detected by the human detection device;
the determine whether the front passenger seat and/or the rear seats of the vehicle is occupied by at least one passenger is based on the detection data from the human detection device.

19. The system of claim 11, the output device is further configured to output warning messages in the form of text, image, and/or voice.

20. A vehicle, comprising:
a vehicle body,
a parking warning system, wherein the parking warning system is arranged in the vehicle body for controlling the vehicle body and comprises:
an environmental detection device, configured to detect environmental detection data between a vehicle and surrounding obstacles;
a control device, configured to:
determine an operational status of the vehicle;
acquire, in real-time, the environmental detection data between the vehicle and obstacles surrounding the vehicle at a preset distance, when the operational status of the vehicle indicates the vehicle is on a trajectory to a parking space;
estimate a drop-off distance, before the vehicle is parked, and based on the environmental detection data, wherein the drop-off distance indicates distances between the vehicle and the obstacles if the vehicle continues on the trajectory to the parking space;
output a warning message when the drop-off distance is less than or equal to a distance threshold;
an output device, configured to output the warning message.
